(19) United States
(12) Patent Application Publication
(10) Pub. No.: US 2016/0032120 A1
(43) Pub. Date: Feb. 4, 2016

(54) COLORANT

(71) Applicant: HEWLETT-PACKARD DEVELOPMENT COMPANY, L.P., Houston, TX (US)

(72) Inventors: Jan Morovic, Colchester (GB); Peter Morovic, Barcelona (ES); Peter J. Klammer, Corvallis, OR (US); James William Stasiak, Lebanon, OR (US)

(21) Appl. No.: 14/447,882

(22) Filed: Jul. 31, 2014

(51) Int. Cl. C09D 11/32; C09D 11/02

(52) U.S. Cl. CPC C09D 11/32; C09D 11/02

(57) ABSTRACT

A colorant for a printing apparatus is described. The colorant has a first component and a second component. The first component is configured to reflect radiation having a first set of wavelengths when the colorant is arranged on a substrate. The second component is configured to absorb radiation having a second set of wavelengths and emit radiation having a third set of wavelengths when the colorant is arranged on the substrate, the first and third set of wavelengths having at least one common wavelength.

### BACKGROUND

A typical printing apparatus is based on a subtractive color model and uses subtractive colorants such as, for example, C (cyan), M (magenta), Y (yellow) and K (black) inks. By overprinting images for each of the colorants, an image with a range of different colors can be printed. Colorants such as these mostly reflect light with a range of wavelengths in one part of the electromagnetic spectrum and mostly absorb light with a range of wavelengths in a different part of the electromagnetic spectrum. Such colorants partly reflect and partly absorb light at each wavelength. The relative proportion of incident light that is reflected and absorbed varies with wavelength. For example, a cyan colorant reflects incident light with a wavelength in the green and blue parts of the electromagnetic spectrum and absorbs other wavelengths in the red part of the electromagnetic spectrum. Subtractive colorants such as these reduce the amount of light which is reflected compared with the amount of light reflected by a bare substrate without the colorant arranged on it. There is thus a limit to the brightness of colors printed in this manner.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic illustration showing a printing system for producing a print output according to an example;

FIG. 2 is a schematic illustration showing a reflective colorant arranged on a substrate according to an example;

FIG. 3 is a schematic illustration showing a colorant according to examples described herein arranged on a substrate;

FIG. 4 is a schematic diagram of an image processing pipeline according to an example;

FIG. 5 is a schematic illustration of a Neugebauer Primary area coverage vector according to an example;

FIG. 6 is a flow chart showing a method for generating a color mapping according to an example; and

FIG. 7 is a schematic illustration of an imaging system according to an example.

### DETAILED DESCRIPTION

In the following description, for the purpose of explanation, numerous specific details of certain examples are set forth. Reference in the specification to “an example” or similar language means that a particular feature, structure, or characteristic described in connection with the example is included in at least that one example, but not necessarily in other examples.

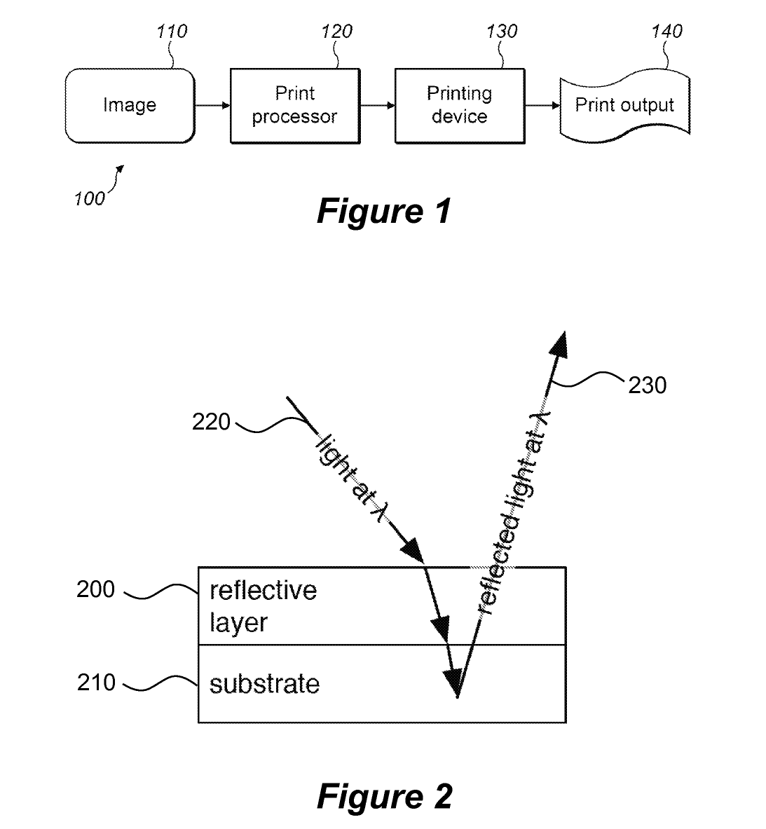

FIG. 1 shows schematically a printing apparatus 100 that may be used with one or more colorants including a colorant configured according to certain examples described herein. Image data corresponding to an image 110 is sent to a print processor 120. The print processor 120 processes the image data. It then outputs print control data that is communicated to a printing device 130. The printing device 130 is arranged to use the plurality of colorants to produce a print output 140 on a substrate. The term “colorant” as used herein refers to any substance suitable for printing, including, amongst others an ink, a gloss, a varnish and a coating; these include printing fluids such as liquid electrophotographic inks as well as non-fluid printing materials, for example a toner, a wax or a powder used in laser printing or dry electrophotography, or a binder or fluid used in three-dimensional printing; any references to “ink” as used below include a colorant as so defined. The substrate may be any two or three dimensional substrate. The printing device 130 may comprise an ink-jet printer with a number of print heads that are arranged to emit a plurality of colorants. The print output 140 comprises portions of colorant that are deposited onto the substrate by way of the printing device 130. In the example of FIG. 1, an area of the print output 140 may, depending on the image data 110, comprise a colorant overprint, in that a portion of a first deposited colorant may be overprinted with a portion of at least a second deposited colorant. The print control data has defined values for depositions with each combination of the colorants. In certain cases the print control data may comprise a distribution vector that specifies a distribution of colorant depositions, e.g. a probability distribution for each colorant and/or colorant combination for a pixel of a print image or, in other words, an area coverage vector for a set of colorant combinations or overprints.

FIG. 2 shows a schematic example of a reflective colorant 200 according to an example. The reflective colorant 200, when arranged on a substrate 210, absorbs a portion of incident radiation 220 with a wavelength of X, and reflects another portion of incident radiation 220 having the wavelength of X, such that reflected radiation 230 leaves the substrate 210 with a wavelength X. In certain examples described herein, the term “radiation” refers to electromagnetic radiation of any wavelength and electromagnetic radiation within the visible part of the electromagnetic spectrum is referred to herein as “light”. In certain examples, the reflective colorant 200 reflects electromagnetic radiation having a wavelength within a given set or range of wavelengths, for example a range of wavelengths within the visible spectrum. Electromagnetic radiation with a wavelength outside this range of wavelengths is absorbed. In such examples, the reflective colorant 200 may absorb a portion of and reflect a different portion of light with a wavelength within that given range of wavelengths.

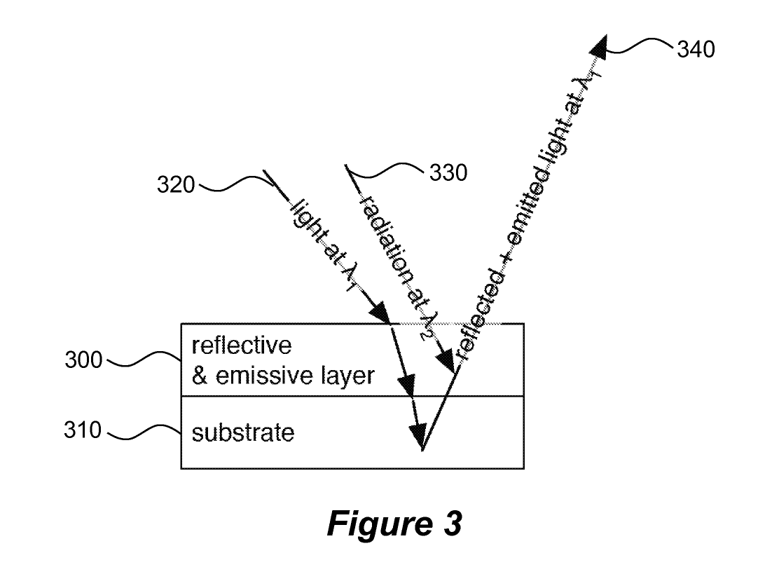

A reflective and emissive colorant 300 according to an example is shown arranged on a substrate 310 in FIG. 3. The colorant 300 comprises a first component configured to reflect radiation having a first set of wavelengths when the colorant 300 is arranged on the substrate 310. The colorant 300 also comprises a second component configured to absorb radiation having a second set of wavelengths and emit radiation having a third set of wavelengths when the colorant 300 is arranged on the substrate 310. In the example, of FIG. 3 there is an overlap between the first and third set of wavelengths, e.g. light of one or more common wavelengths may be more reflected and emitted by the colorant.

In such examples, the second component may be configured to absorb energy from at least a portion of incident radiation having the second set of wavelengths and to emit at least a portion of the absorbed energy as radiation having the third set of wavelengths. In some cases, the second and third sets of wavelengths comprise different wavelengths. For example, the second component may absorb a certain proportion of incident photons, i.e. incident radiation, with wavelengths in the second set of wavelengths and then re-emit photons with different wavelengths, for example wavelengths in the third set of wavelengths. The total energy of the re-emitted photons in examples is less than or equal to the energy of the photons absorbed by the second component. The number of photons absorbed by the second component may be less than the number of photons incident on the reflective and emissive colorant 300.

In certain cases, one or more of the first and second components may define a reflectance spectrum. However, by way of the second component, in certain portions of the spectrum, a reflectance value for a given wavelength may exceed 100%, i.e. all incident radiation at that wavelength being reflected, due to emission at that wavelength, the energy for emission being absorbed in a wavelength range represented by the second set of wavelengths. In certain cases, the reflective and emissive colorant 300 may also be defined by a general spectrum that indicates a modelled and/or measured intensity or power value for a given range of wavelengths.

In the example shown in FIG. 3, when the colorant 300 is arranged on the substrate 310, incident radiation 320 with a set of wavelengths denoted λ₁ is reflected by the first component of the colorant. Incident radiation 330 with a set of wavelengths denoted λ₂ is absorbed by the second component of the colorant 300, causing the second component to emit radiation with at least one wavelength that is also reflected by the first component, i.e. with the set of wavelengths λ₁. Thus, the radiation 340 which leaves the substrate 310 comprises reflected radiation and emitted radiation, with at least one common wavelength in the set Incident radiation 330 may comprise one or more of visible light and non-visible radiation, e.g. ultra-violet radiation.

In examples, the first component of the colorant 300 may absorb a portion of incident radiation at a given wavelength and reflect another portion of the incident radiation at that given wavelength. The relative proportions of radiation absorbed and reflected by the first component may be different for different wavelengths of incident radiation. As such spectra representing the relative proportions of reflectance and absorption across the visual spectrum may define the perceived “color”. The term “reflect” in examples includes reflection of at least a portion of incident radiation at a certain wavelength and is not limited to reflection of all incident radiation at that wavelength. The term “set of wavelengths” as used herein includes a set of one wavelength and, in examples, may refer to a range of wavelengths or multiple ranges of wavelengths which may be continuous or non-continuous.

The first component may comprise a reflective colorant, for example a cyan, magenta, yellow or black ink in a four colorant printing system. In such examples, the first set of wavelengths reflected by the first component, e.g. the wavelengths that are reflected in particular proportions as opposed to being absorbed, is in a part of the visible spectrum corresponding to a subtractive primary color, e.g. one of cyan, magenta, yellow or black. In further examples, the first component is configured to reflect radiation having a first set of wavelengths lying anywhere in the visible spectrum, for example any wavelength within the range of 400 to 700 nanometers. For example, the first component may be any ink or colorant with a defined color, e.g. as represented by a particular reflectance spectrum. For example, the first component may have a predetermined reflectance profile or function, the predetermined reflectance profile or function indicating reflectance above a first reflectance value threshold for at least a first wavelength range within the first set of wavelengths, the range being within a visible range of wavelengths. The first threshold may be, for example, a half-maximum value or any other value that defines the range.

As explained above, in some cases, the first set of wavelengths reflected by the first component may include a continuous or non-continuous set of wavelengths. In examples, the first component also reflects radiation with wavelengths which are not in the first set of wavelengths. For example, the portion of radiation reflected by the first component for wavelengths within the first set of wavelengths may be greater than the portion of radiation reflected by the first component for wavelengths outside the first set of wavelengths. At least a portion of radiation not reflected by the first component for a given wavelength of incident radiation may be absorbed and/or transmitted, e.g. to the substrate. For example, the first component may be configured to absorb a set of wavelengths outside the first set of wavelengths and a first portion of incident radiation having the first set of wavelengths, and reflect a second portion of incident radiation having the first of wavelengths, the second portion being greater than the first portion. In this case, the proportion of radiation reflected by the first component with wavelengths in the first set of wavelengths is larger than the proportion of radiation absorbed and/or transmitted. The first set of wavelengths may therefore include wavelengths at which the first component predominantly reflects incident radiation, for example at which it reflects more radiation than it absorbs and/or transmits, or at which it reflects more radiation than at other wavelengths. In any case a particular first component may be defined by a reflectance spectrum that, for each wavelength in a given range such as the visible spectrum, has a reflectance value that is representative of the portion of incident radiation that is reflected, with the remaining portion being absorbed by one or more of the component and the substrate.

In one example, the second component comprises one or more additives that configure spectral properties of the colorant, e.g. the measured spectrum when the colorant is deposited on a substrate. In certain cases, the one or more additives may emit a narrow-band of specific wavelengths anywhere in the visible range of wavelengths when illuminated by electromagnetic radiation comprising particular wavelengths or wavelength ranges, including generic, common light sources. Outside of this narrow-band the second component may absorb radiation. In certain cases, the one or more additives may emit a set of wavelength that need not be narrow-band, e.g. the second component may have a discontinuous broad-band emission profile. This may be achieved with combinations of different additives. For example, the one or more additives may have a predetermined emission profile or function, the predetermined emission profile or function indicating emission above a second emission threshold of at least one wavelength within the first wavelength range described above. The second threshold may be, for example, a half-maximum value or any other value that defines the range.

An additive in this example is arranged to emit radiation at at least one of the wavelengths as radiation reflected by the first component. In certain cases, there may be at least an overlap between reflected and emitted wavelengths, such that at least one wavelength is both reflected and emitted. In one case, the second component comprises at least one quantum dot material. For example, the second colorant may comprise a quantum dot material component with a concentration of less than 1% by weight to around several % by weight. Quantum dots comprise semi-conductor-like materials that may be configured and manufactured such that they exhibit narrow-band emission spectra within the visible range. These spectra may have a controlled peak location and a controlled full width at half maximum (FWHM). For example, quantum dots of the same material but different sizes may emit light in different wavelength ranges due to the quantum confinement effect. For certain materials, the larger the quantum dot the longer the wavelength of the spectral peak (e.g. the redder the perceived output); while the smaller the quantum dot the shorter the wavelength of the spectral peak (e.g. the bluer the perceived output). Quantum dots may range from 2 to 50 nm in size for certain materials and production techniques. In certain cases shell size may also be configured to affect the properties of the quantum dot. A conversion or quantum yield may not be 100%, e.g. not all of the absorbed energy is emitted, but for some materials it may be up to 80-90%. Quantum dots may also be configured to absorb light outside of the visible range, for example light in the ultra-violet or infra-red range. The size of the quantum dot may be chosen to absorb radiation having the second set of wavelengths and emit radiation having the third set of wavelengths. In examples, the second component comprises one or more of: a photoluminescent component, at least one quantum dot, or at least one nanocrystal. In some cases the second component may comprise any additive that provides narrow-band spectral emission.

In one implementation an additive may comprise a cadmium-free material such as CuInS/ZnS or InP/ZnS in a core/shell arrangement. Additives may be those supplied by, amongst others, NN Labs LLC of Fayetteville, USA; American Elements of Los Angeles, USA; and MkNano of Mississauga, Canada. An additive may be selected such that the colorant absorbs energy from incident radiation having the second set of wavelengths, such as ultra-violet radiation, and emits photons at the third set of wavelengths. The properties of an additive may be determined by the physical size of nanoparticles of the additive. A width of an emission band may be determined by a distribution of particle diameters in an additive material. A colorant may comprise more than one type of additive, e.g. may comprise quantum dots of a variety of sizes so as to configure a spectral output of the colorant, wherein each size of quantum dot emits a specific wavelength or narrow wavelength band. In this case, collectively, as an ensemble, the distribution of diameters will yield a range of wavelengths that are emitted.

In certain cases, the set of wavelengths absorbed by the second component of the colorant, is in the visible part of the electromagnetic spectrum. Where both the first and third set of wavelengths are in the visible spectrum, a colorant arranged on the substrate and illuminated by ambient visible light will see increased reflectance and emittance within the first set of wavelengths as compared with comparative reflective colorants. Therefore, in these examples, there is no need to illuminate the colorant with a special type of radiation, for example radiation which is outside the visible spectrum such as ultra-violet or infra-red radiation, in order to see increased reflectance and emittance at the first set of wavelengths.

In certain cases, the first component may reflect a continuous range of wavelengths, for example a range of wavelengths in a certain part of the electromagnetic spectrum, for example corresponding to a particular color such as a subtractive primary color. In other examples, the first component may reflect wavelengths in a non-continuous set. The third set of wavelengths emitted by the second component may also be either a continuous range or non-continuous set. The first and third sets of wavelengths may at least partially overlap. In some examples, the first and third sets of wavelengths overlap substantially or entirely, i.e. comprise substantially or entirely the same wavelengths. In other examples, the first and third sets of wavelengths partly overlap, for example with less than 50% or less than 25% of wavelengths in common.

In certain cases, a reflectance or power distribution value for one or more sampled or modelled wavelengths of the colorant, when the colorant is arranged on the substrate and illuminated by radiation having the first set of wavelengths and the second set of wavelengths, exceeds a reflectance or power distribution value indicative of all incident radiation having the first set of wavelength being reflected from the colorant when the colorant is arranged on the substrate. In this case, the term “reflectance value” is used in this context to refer to the measured or modelled properties or characteristics of the proportion of radiation that leaves an object. An example may include a recorded spectrum, such as a spectrum indicating an optical property corresponding to a plurality of detectors at a number of sampled wavelengths. For example, a reflectance value may comprise the number of photon counts falling on a photon detector at a particular wavelength relative to the number of photons emitted by a photon source illuminating the object at that wavelength. In these examples, the total amount of radiation which is reflected and emitted by the colorant at one or more common wavelengths is larger than the amount of radiation which is reflected by a comparative reflective colorant when arranged on a substrate or the amount of radiation which would be reflected by the colorant if it did not comprise the second component. The term “amount of radiation” may refer to a number of photon counts or another measurement of light intensity or flux, for example. The colorant in these examples thus produces brighter colors when printed compared with known reflective colorants.

In further examples, a reflectance of the colorant when the colorant is arranged on the substrate and illuminated by radiation having the first set of wavelengths and the second set of wavelengths exceeds a value indicative of all incident radiation having the first set of wavelengths being reflected from the substrate. In such examples, the amount of light reflected and emitted by the colorant at the first set of wavelengths is greater than the amount of radiation reflected by the substrate without the colorant arranged on it. For example, the reflectance of the colorant when it is arranged on a substrate may be greater than the reflectance of a perfect diffuser which reflects all radiation at each wavelength.

In the above-described examples, the term “reflectance” may refer to a normalized reflectance. With a comparative reflective colorant, the normalized reflectance has a value between 0 and 1 (i.e. between 0 and 100%). However, as explained above, the reflectance of a combination of the first and second colorants may have a normalized reflectance outside this range, e.g. the normalized reflectance of the combination of the first and second colorants may be larger than 1 (i.e. greater than 100%). In particular implementations, the effective reflectance need not be greater than 100% in a region of the visible spectrum to provide an enlarged gamut. Certain implementations may have regions above and/or below 100% effective reflectance.

This effect is surprising in view of any comparative methods for increasing the brightness of printed ink. Such methods include the use of optical brightening agents, for example comprising fluorescent additives, in a substrate. Optical brightening agents allow the substrate to reflect more than 100% of incident light. However, the reflectance of a known reflective ink printed on the substrate still does not exceed the reflectance of the substrate. Furthermore, dot gain, in which the substrate scatters incident radiation so it exits under a printed area (“dot”) rather than through an unprinted area of the substrate, reduces the reflectance of a comparative reflective ink further such that, in examples, a comparative reflective ink reflects less than 100% of incident radiation when arranged on a substrate which reflects more than 100% of incident radiation without the comparative reflective ink arranged on it. Therefore, the use of optical brightening agents does not allow a reflectance of a printed reflective ink to exceed the reflectance of the substrate; the brightness of the print is therefore still limited relative to the brightness of the substrate itself. This is in contrast to the colorant according to certain examples described herein in which the reflectance of the colorant when arranged on a substrate exceeds a reflectance of the substrate without the colorant arranged on it.

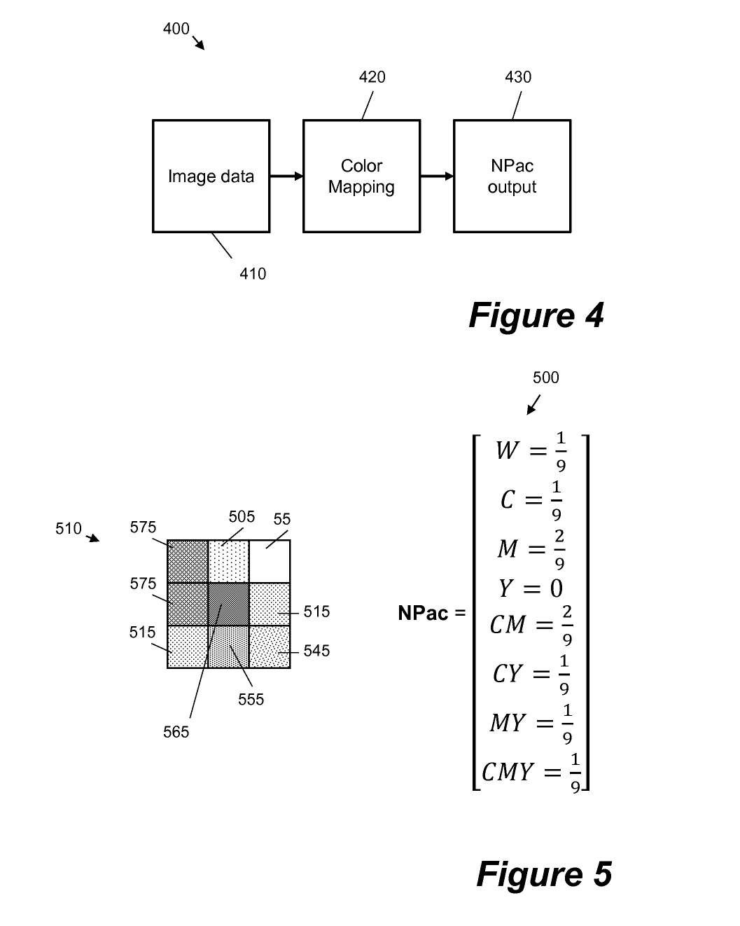

In a printing apparatus, a process of color mapping may be used to map a first representation of a given color to a second representation of the same color. The process of color mapping for a printing apparatus comprising the colorant according to examples must be tailored to allow for the normalized reflectance of the colorant when arranged on the substrate to exceed 100% relative to the normalized reflectance of the substrate itself. For the purposes of explanation, comparative methods of color mapping will first be described with reference to the example image processing pipeline illustrated in FIG. 4. Then, the method of color mapping for a printing apparatus including a colorant according to examples will be described.

Although “color” is a concept that is understood intuitively by human beings, it can be represented in a large variety of ways. Color intrinsically relates both to a physical stimulus as well as to its perception or interpretation by a human or artificial observer under a given set of conditions. The physical foundation relates to the spectral power distributions of the illuminating light source and the reflective or transmissive properties of an object or surface as well as the observers' spectral sensitivities. Further elements affect color, such as temporal or spatial effects. The perception of color is then the joint effect of all this elements. There are different ways to describe color, the descriptions differing, for example, in how limited their validity is. For example, in one case a surface may be represented by a power or intensity spectrum across a range of visible wavelengths. This provides information about a physical property of the surface, but not about the ultimate color as that also depends on the illuminant and an observer, spatial context etc.. At the other extreme, a surface's color can be described with all other conditions fixed, e.g. the tristimulus values of the surface under an average intensity daylight-simulating illuminant against a gray background, in which case a Color Appearance Model would be used to describe it. In other cases, a “color” may be defined as a category that is used to denote similar visual perceptions; two colors are said to be the same if they produce a similar effect on a group of one or more people. These categories can then be modelled using a lower number of variables.

Within this context, a color model may define a color space. A color space in this sense may be defined as a multi-dimensional space, wherein a point in the multi-dimensional space represents a color value and dimensions of the space represent variables within the color model. For example, in a Red, Green, Blue (RGB) color space, an additive color model defines three variables representing different quantities of red, green and blue light. Other color spaces include: a Cyan, Magenta, Yellow and Black (CMYK) color space, wherein four variables are used in a subtractive color model to represent different quantities of colorant, e.g. for a printing system; the International Commission on Illumination (CIE) 1931 XYZ color space, wherein three variables (‘X’, ‘Y’ and ‘Z’ or tristimulus values) are used to model a color, and the CIE 1976 (L*, a*, b*—CIELAB or ‘LAB’) color space, wherein three variables represent lightness (‘L’) and opposing color dimensions (‘a’ and ‘b’). Certain color spaces, such as RGB and CMYK may be said to be device-dependent, e.g. an output color with a common RGB or CMYK value may have a different perceived color when using different imaging systems.

When working with color spaces, the term “gamut” refers to a multi-dimensional volume in a color space that represents color values that may be output by a given imaging system. A gamut may take the form of an arbitrary volume in the color space wherein color values within the volume are available to the imaging system but where color values falling outside the volume are not available. The terms color mapping, color model, color space and color gamut, as explained above, will be used in the following description.

FIG. 4 shows an example of an image processing pipeline 400. The image processing pipeline 400 receives image data 410 that is passed into a color mapping component 420. The image data 410 may comprise color data as represented in a first color space, such as pixel representations in an RGB-based color space. The color mapping component 420 maps the color data from the first color space to a second color space. The second color space in the image processing pipeline 400 comprises a Neugebauer Primary area coverage (NPac) color space. NPac color space is used as a domain within which a color mapping process and a halftoning process communicate, i.e. an output color is defined by an NPac value that specifies a particular area coverage of a particular colorant combination. In the image processing pipeline, a halftone image on a substrate comprises a plurality of pixels or dots wherein the spatial density of the pixels or dots is defined in NPac color space and controls the colorimetry of an area of the image, i.e. any halftoning process simply implements the area coverages as defined in the NPacs. As such, in the context of the image processing pipeline 400, the term “color separation”, referring to an NPac output, combines elements of both a color mapping and halftoning process. An example of an imaging system that uses NPac values in image processing is a Halftone Area Neugebauer Separation (HANS) pipeline.

An NPac represents a distribution of one or more Neugebauer Primaries (NPs) over a unit area. For example, in a binary (bi-level) printer, an NP is one of 2^{k} combinations of k inks within the printing system. For example, if a printing device uses CMY inks there can be eight NPs. These NPs relate to the following: C, M, Y, C+M, C+Y, M+Y, C+M+Y, and W (white or blank indicating an absence of ink). In relation to the present examples a plurality of NPs for a given printing system may comprise an adapted colorant with reflective and emissive properties and its various combinations of overprints, e.g. with the other colorants of the printing system. In one case, there may be a plurality of colorants with reflective and emissive properties as described in examples herein. In yet a further case, all colorants within a printing system may have these properties. Other examples may also incorporate multi-level printers, e.g. where print heads are able to deposit N drop levels; in this case an NP may comprise one of N^{k} combinations of k inks within the printing system. An NPac space provides a large number of metamers. Metamerism is the existence of a multitude of combinations of reflectance properties that result in the same perceived color, as for a fixed illuminant and observer.

Although certain printing device examples are described with reference to one or more colorant levels, it should be understood that any color mappings may be extended to other colorants such as glosses and/or varnishes that may be deposited in a printing system and that may alter a perceived output color; these may be modelled as NPs.

FIG. 5 shows an example of a three-by-three pixel area 510 of a print output where all pixels have the same NPac vector: vector 500. The NPac vector 500 defines the probability distributions for each NP for each pixel, e.g. a likelihood that NPx is to be placed at the pixel location. Hence, in the example print output there is one pixel of White (W) (535)—e.g. bare substrate; one pixel of Cyan (C) (505); two pixels of Magenta (M) (515); no pixels of Yellow (Y); two pixels of Cyan+Magenta (CM) (575); one pixel of Cyan+Yellow (CY) (545); one pixel of Magenta+Yellow (MY) (555); and one pixel of Cyan+Magenta+Yellow (CMY) (565). Generally, the print output of a given area is generated such that the probability distributions set by the NPac vectors of each pixel are fulfilled. As such, an NPac vector is representative of the ink overprint statistics of a given area. Any error between a proposed set of colorant distributions and a given set of pixels may be diffused or propagated to neighboring pixel areas, such that for a given group of pixels this error is minimized. Any subsequent processing effects the probability distributions, e.g. in any halftoning process. When used with the colorants of the present examples, one or more of the example CMY inks may comprise additives that provide emissive properties.

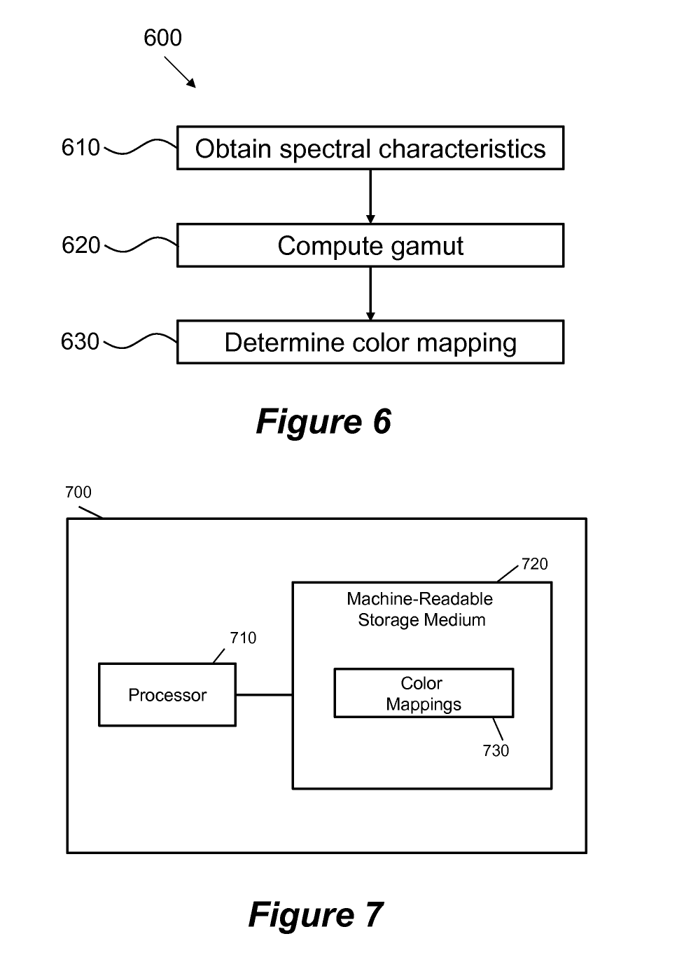

FIG. 6 shows a method 600 for generating a color mapping for a printing apparatus including one or more of the previously descried colorants according to an example. At block 610 spectral characteristics are obtained for one or more colorants. At least one of the one or more colorants is a colorant according to certain examples described herein. The term “spectral characteristics” includes any spectral property of the colorant, for example its reflectance, emission and/or any variation of a particular optical property which depends on the wavelength illuminating the colorant. Both emissive and absorptive properties may be obtained. This may be achieved through one or more of measurement and modelling. In one implementation, an ink template may be used. In this implementation, an image may be printed with a number of test patches. The test patches may comprise different distributions of each of a plurality of colorants. For example, each test patch may be printed based on a different NPac vector, i.e. with different proportions of different ink-overprints in a given area. In certain cases, the different ink-overprints may comprise combinations of reflective colorants and colorants with both reflective and emissive properties as described herein. These ink-overprints have both reflective and emissive properties due to the first and second components of the colorant according to examples, respectively. After printing, the test patches are illuminated with a light source. The light source in certain examples produces electromagnetic radiation at a range of wavelengths and may be a generic, common light source. The range of wavelengths may be in the visible spectrum and, in further examples, includes the third and/or second wavelengths the second component of the colorant is configured to emit and absorb radiation at, respectively.

The spectral properties of the illuminated test patches may then be measured, e.g. using a spectrometer or spectrophotometer, which may or may not form part of the printing system. For example, the spectral characteristics may be measured by scanning the illuminated test patches between a predetermined range of wavelengths in a chosen number of steps. For example, a built-in spectrophotometer may be able to measure visible wavelengths, for example in the range 400 nm to 700 nm. Spectral characteristics may be obtained from a spectrum of a measured color. Measurements may be integrated across intervals of width, D, such that the number of intervals, N, equals the spectral range divided by D. In one example, the spectral range may be 400 nanometers to 700 nanometers and D may be 20 nanometers, resulting in values for 16 intervals. D may be configured based on the specific requirements of each example. Each value may be a value of reflectance, e.g. measured intensity, or a normalized reflectance/emission value. However, in this case, this reflectance value measures light both reflected and emitted by the custom colorants described herein. In this case, as described above, a “reflectance value” output by a spectrometer or spectrophotometer may exceed 100%. Spectral characteristics may include spectral properties of the printed inks such as the intensity of each wavelength measured for each test patch and this can take the form of a spectrum of wavelengths in which each test patch gives a different intensity response.

The device for measuring the spectral characteristics in examples allows for values, for example of the reflectance, which exceed the spectral characteristics of a perfect diffuser which reflects all light at each wavelength. For example, in typical surface color applications based on reflective color formation, materials can at most reflect all of the incident light at each wavelength. Therefore, for reflective colorants, a device for measuring the reflectance sets may limit measured reflectance values to 100%, i.e. to values that indicate a reflectance of no more than all the incident light at each wavelength being reflected, e.g. a reflectance value of 100%. For emissive colorants as described herein, a device for measuring the spectral characteristics may measure reflectance values that exceed 100%, i.e. which exceed the reflectance expected due to reflection of all incident light, due to the emissive properties.

In another implementation, values for spectral characteristics or properties may be obtained from an accessible resource, such as a network and/or storage device.

In certain examples, spectral characteristics are obtained for a plurality of colorant Neugebauer primaries, each colorant Neugebauer primary representing an available colorant overprint combination, by determining spectral characteristics for respective colorant Neugebauer primaries having one or more colorant coverage values for a unit area of a substrate. The plurality of colorant Neugebauer primaries in certain examples are each based on a different NPac vector comprising different proportions of different ink-overprints in a unit area, as explained above. In certain cases, the spectral characteristics may only be measured for primary inks, where in examples the primary inks include a colorant according to examples. In these cases spectral characteristics for non-primary ink-overprints, e.g. colorant Neugebauer primaries, may be determined based on the spectral properties of the primary inks, e.g. using spectral modeling.

At block 620 a gamut of colors available to the printing apparatus is computed based on the spectral characteristics obtained at block 610. In certain cases, a set of computed colorant Neugebauer primary, e.g. NP, reflectance values may be modelled in an N-dimensional space referred to as spectral space. Spectral space is a mathematically-defined N-dimensional space in which each point in spectral space is defined by an N-dimensional co-ordinate. In this case each co-ordinate value is a reflectance value for a particular wavelength interval (e.g. a sampled spectrum value). Hence, a set of reflectance values for a particular NP represents a point in the N-dimensional space. The space between the plotted points can be interpolated to obtain any reflectance enclosed by their convex hull, since each point within that hull is a convex combination of some of the NPs delimiting it. The reflectances enclosed within the convex hull correspond with the gamut of colors available to the printing apparatus. In certain case a gamut is determined in an output color space, e.g. an NPac space. The modelled colorant NP values in spectral space may be processed to determine the gamut in NPac space.

In a comparative method of generating a color mapping, ink limits are applied to reduce the gamut to a gamut comprising reflectances which are printable by the printing device. For example, ink limits may be applied to remove reflectances which exceed a reflectance value indicative of all incident radiation being reflect as it is not possible to achieve such a reflectance value with known reflective inks.

In a method of generating a color mapping according to certain examples, the gamut of colors available to the printing apparatus incorporates reflectance values that exceed a reflectance value indicative of all incident radiation being reflected. Therefore, the method of color mapping according to these examples does not include applying such ink limits, or the ink limits applied are modified to include reflectance values outside the 0% and 100% range imposed with conventional ink limits. For example, the computation of the color gamut in some cases accounts for the fact that the white point of a print may not be the lightest printable color. This may be done by removing cut-offs to the 0 to 100% reflectance range which is used in a known printing apparatus to avoid apparently “unrealistic” values arising from noise.

Therefore, the printable gamut is larger than that obtainable with a comparative method of color mapping and with comparative colorants, such as non-adapted CMYK colorants. In particular, in examples in which each of the colorants of the plurality of colorants is a colorant according to examples, the printable gamut is larger than that which may be achieved with the same number of comparative reflective colorants.

In such examples, the colors obtained in the computed color gamut may exceed the color gamut of all reflective surfaces i.e. the Object Color Solid (OCS). However, such colors are not excluded from the printable color gamut using the method of generating a color mapping according to examples. Instead, for example the gamut of colors available may be computed within a color space unconstrained by its precise definition, e.g. CIELAB or the IPT color space, where I, P, T denote the lightness, red-green and yellow-blue dimensions respectively. Alternatively, the color gamut may be extrapolated beyond the OCS when using a color space which is constrained, e.g. the CIECAM02 color space.

At block 630 a color mapping is determined that enables a mapping of color values from an input color space to an output color space associated with the plurality of colorants based on the computed gamut. For example, the computed gamut as described above may be used to provide a mapping of spectral characteristics corresponding to sampled colors within an input color space to one or more colorant coverage values for a unit area of a substrate, e.g. an NPac, within an output color space. In one case, the color mapping may comprise a color separation in the form of a look-up table that provides a mapping from input colorimetry to NPac vectors based on NPs which may be composed of a plurality of emissive inks or reflective and emissive inks stacked on top of each other. In certain cases there may be a multitude of NPacs that correspond to any one ink-vector as used by comparative printing systems. Each of these NPacs however has a different combination of reflectance and colorimetry and therefore gives access to a much larger variety or printable gamut. For example, multiple NPacs may have the same colorimetry (being that colorimetry's metamers) while differing in spectral reflectance. There may also be multiple NPacs with the same reflectance but with different use of the available NPs.

The input color space in certain cases is a device-dependent color space. For example, the input color space may comprise a Red, Green, Blue (RGB) color space, a Cyan, Magenta, Yellow and Black (CMYK) color space, or a CIE XYZ color space. A device-independent color space, e.g. a CIELAB space may be used as an intermediate color space, e.g. a color mapping may incorporate an RGB-based to XYZ-based to NPac color mapping or a XYZ-based to NPac color mapping.

Further examples relate to a printing apparatus configured to deposit a plurality of colorants onto a substrate, the plurality of colorants including a colorant according to certain examples described herein. The printing apparatus may comprise, for example, one or more reflective inks as well as one or more colorant with both reflective and emissive properties. In such examples, the one or more reflective inks and the one or more colorants with both reflective and emissive properties may all have different colors, i.e. they may all reflect light having different wavelengths, or one or more of the inks may have overlapping colors, in which an ink reflects a set of wavelengths which partly overlaps with a set of wavelengths reflected by a different ink. In other examples, the printing apparatus comprises only colorants with both reflective and emissive properties. The printing apparatus may, for example, comprise colorants which reflect and emit light having wavelengths corresponding to subtractive primary colors, such as cyan, magenta, yellow and black.

The printing apparatus may further comprise an imaging system comprising a look-up table comprising a plurality of nodes, each node being configured to map a color value from an input color space to an output color space, for example using the method for generating a color mapping as described above. The imaging system in such examples is arranged to process an input image using the look-up table and generate a halftone output comprising a color value in the output color space. The halftone output is indicative of an amount to be printed of one or more of the plurality of colorants, the one or more of the plurality of colorants including the colorant. In examples, the halftone output is one or more colorant coverage values for a unit area of the substrate, for example one or more Neugebauer Primary area coverage vectors.

Certain methods and systems as described herein may be implemented by a processor that processes computer program code that is retrieved from a non-transitory storage medium. An example imaging system in accordance with the above-described examples is illustrated in FIG. 7. The imaging system 700 comprises a machine-readable storage medium 720 coupled to a processor 710. In examples the imaging system 700 comprises a printer. Machine-readable media 720 can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc. In FIG. 7, the machine-readable storage medium comprises one or more color mappings 730, which may be in the form of a look-up table.

Certain examples described herein include a method for generating a color mapping for a printing apparatus including a plurality of colorants, the method comprising: obtaining spectral characteristics for the plurality of colorants, at least one colorant comprising a first component configured to reflect radiation having a first set of wavelengths and a second component configured to absorb radiation having a second set of wavelengths and emit radiation having a third set of wavelengths, the first set of wavelengths and the third set of wavelengths comprising at least one common wavelength; computing a gamut of colors available to the printing apparatus in an output color space based on the spectral characteristics, said computing incorporating reflectance values that exceed a reflectance value indicative of all incident radiation of the first set of wavelengths being reflected; and determining a color mapping that enables a mapping of color values from an input color space to the output color space.

In certain cases the method comprises obtaining spectral characteristics for a plurality of colorant Neugebauer primaries, each colorant Neugebauer primary representing an available colorant overprint combination, by determining spectral characteristics for respective colorant Neugebauer primaries having one or more colorant coverage values for a unit area of a substrate. In this case the output color space may comprise, for each output image pixel, a probability distribution for each colorant Neugebauer primary.

Certain examples described herein include a printing apparatus configured to deposit one or more colorants onto a substrate, the one or more colorants including a colorant comprising a first component configured to reflect radiation having a first set of wavelengths when the colorant is arranged on a substrate and a second component configured to absorb radiation having a second set of wavelengths and emit radiation having a third set of wavelengths when the colorant is arranged on the substrate, wherein the first set of wavelengths and the third set of wavelengths comprise at least one common wavelength.

In certain cases, the printing apparatus may be communicatively coupled to an imaging system comprising a look-up table comprising a plurality of nodes, each node being configured to map a color value from an input color space to an output color space, the imaging system being arranged to process an input image using the look-up table and generate a halftone output using a color value in the output color space. In certain cases the color value in the output color space comprises a Neugebauer Primary area coverage vector. The colorant may comprise one of a plurality of colorants, each colorant having a different common wavelength.

Certain examples include a method of printing comprising receiving print control data, wherein the print control data for a given output image pixel is generated based on a Neugebauer Primary area coverage vector for the pixel, the Neugebauer Primary area coverage vector indicates coverage values for a plurality of Neugebauer primaries, each of the plurality of Neugebauer primaries represent an overprint combination for a set of available colorants and the set of available colorants comprise a reflective and emissive colorant. As set out in certain examples herein the reflective and emissive colorant comprises a first component configured to reflect radiation having a first set of wavelengths when the colorant is arranged on the substrate and a second component configured to absorb radiation having a second set of wavelengths and emit radiation having a third set of wavelengths when the colorant is arranged on a substrate, the first set of wavelengths and the third set of wavelengths comprising at least one common wavelength. The method also comprises generating a print output based on the print control data including, for the given output image pixel, depositing the reflective and emissive colorant on the substrate in accordance with the Neugebauer Primary area coverage vector.

The preceding description has been presented to illustrate and describe examples of the principles described. This description is not intended to be exhaustive or to limit these principles to any precise form disclosed. Many modifications and variations are possible in light of the above teaching.

What is claimed is:

1. A colorant for a printing apparatus comprising:
a first component configured to reflect radiation having a first set of wavelengths when the colorant is arranged on a substrate; and
a second component configured to absorb radiation having a second set of wavelengths and emit radiation having a third set of wavelengths when the colorant is arranged on the substrate,
wherein the first set of wavelengths and the third set of wavelengths comprise at least one common wavelength.

2. The colorant of claim 1, wherein a reflectance of the colorant when the colorant is arranged on the substrate and illuminated by radiation having the first set of wavelengths and the second set of wavelengths exceeds a reflectance value indicative of all incident radiation having the first set of wavelengths being reflected from one or more of the substrate and the colorant when the colorant is arranged on the substrate.

3. The colorant of claim 1, wherein the first set of wavelengths are in the visible spectrum.

4. The colorant of claim 3, wherein the second set of wavelengths comprise wavelengths in the visible spectrum.

5. The colorant of claim 3, wherein the first set of wavelengths comprise wavelengths in a part of the visible spectrum corresponding to a subtractive primary color.

6. The colorant of claim 1,
wherein the first component is configured to absorb a set of wavelengths outside the first set of wavelengths and is configured to absorb a first portion of incident radiation having the first set of wavelengths and reflect a second portion of incident radiation having the first set of wavelengths, the second portion being greater than the first portion, and
wherein the second component is configured to absorb energy from at least a portion of incident radiation having the second set of wavelengths and to emit at least a portion of said energy as the radiation having the third set of wavelengths,
the second and third sets of wavelengths comprising different wavelengths.

7. The colorant of claim 1, wherein the second component comprises one or more of: a photoluminescent component, at least one quantum dot material, and at least one nanocrystal material.

8. The colorant of claim 1, wherein the second component comprises at least one quantum dot material, the quantum dot material having a size associated with a narrow-band emission comprising at least the second set of wavelengths.

9. An ink comprising:
a reflective colorant having a predetermined reflectance profile, the predetermined reflectance profile indicating reflectance above a first reflectance threshold for at least a first wavelength range within a visible range of wavelengths;
an emissive colorant comprising one or more additives, the one or more additives having a predetermined emission profile, the predetermined emission profile indicating emission above a second emission threshold for at least one wavelength within the first wavelength range.

10. The ink of claim 9, wherein, when arranged on a substrate and illuminated by electromagnetic radiation, the ink has an intensity value for the at least one wavelength that exceeds an intensity value indicative of all incident electromagnetic radiation having the at least one wavelength being reflected by the ink when arranged on the substrate.

11. The ink of claim 9, wherein the one or more additives comprise a quantum dot material with an emission function having a peak wavelength and a defined full-width at half-maximum value indicating a second wavelength range that includes the at least one wavelength within the first wavelength range.

12. The ink of claim 9, wherein the one or more additives are arranged to absorb electromagnetic radiation outside of the first wavelength range.

13. The ink of claim 9, wherein the first wavelength range comprises wavelengths in a part of the visible range corresponding to a subtractive primary color.

14. The ink of claim 9, wherein the reflective colorant is configured to absorb a set of wavelengths outside the first wavelength range and is configured to absorb a first portion of incident radiation having the first wavelength range and reflect a second portion of incident radiation having the first wavelength range, the second portion being greater than the first portion, and
wherein the one or more additives are configured to absorb energy from at least a portion of incident radiation and to emit at least a portion of said energy as the radiation within the first wavelength range.

15. The ink of claim 9, wherein the one or more additives comprises one or more of: a photoluminescent component, at least one quantum dot material, and at least one nanocrystal material.
